(19) United States
(12) Patent Application Publication
(10) Pub. No.: US 2009/0302000 A1
(43) Pub. Date: Dec. 10, 2009

(54) PATTERN FORMING METHOD

(76) Inventor: Shinichi ITO, Yokohama-Shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/478,177

(22) Filed: Jun. 4, 2009

(30) Foreign Application Priority Data
Jun. 5, 2008 (JP) 2008-147972

(51) Int. Cl. B44C 1/22

(52) U.S. Cl. 216/37; 216/94; 216/84

(57) ABSTRACT

A pattern forming method according to an embodiment of the present invention includes forming, on a substrate, a base pattern having a space part, adjusting a width of the space part to make a bottom width of the space part closer to an upper width of the space part, and forming a modified base pattern having a space part whose bottom width is smaller than the bottom width of the space part of the base pattern, by a process of forming a deposition film on the substrate and the base pattern, and a process of removing the deposition film from a bottom of the space part of the base pattern.

### CROSS REFERENCE TO RELATED APPLICATION

This application is based upon and claims the benefit of priority from the prior Japanese Patent Application No. 2008-147972, filed on Jun. 5, 2008, the entire contents of which are incorporated herein by reference.

### BACKGROUND OF THE INVENTION

1. Field of the Invention

The present invention relates to a pattern forming method.

2. Background Art

One of methods for miniaturizing a space part of a resist pattern is a RELACS (Resolution Enhancement Lithography Assisted by Chemical Shrink) technique. In the method, a special upper film is coated on the space part of the resist pattern and a process of heating the upper film is performed. Accordingly, an acid component in the resist pattern and the coated film form a thermosetting layer. Subsequently, the coated film is rinsed with pure water to remove the coated film other than the thermosetting layer. As a result, the space part is miniaturized to a small space part (Mitsubishi Electric Corporation Technical Reports, February issue, 1999 “Technique “RELACS” for forming hole pattern of 0.1 μm for semiconductor”, http://www.mitsubishielectric.co.jp/giho/9902/9902.html).

Further, a method of miniaturizing a space part of a resist pattern by forming a thin deposition film on the resist pattern is disclosed in an article ““Lam Research Corporation's 2300 Motif Post-lithography Pattern Enhancement System Breaks Advanced Lithography Barrier”, http://www.lamrc.com/2300_Motif/index. html” and in an article ““A novel plasma-assisted shrink process to enlarge process windows of narrow trenches and contracts for 45 nm node applications and beyond”, Advances in Resist Materials and Processing Technology XXIV, Proc. of SPIE Vol. 6519, 65190U, (2007)”. According to the method, the space part close to limitation resolution can be further miniaturized.

In forming the space part (opening part) close to the limitation resolution, the shape of the space part may become a skirt shape or a partly open shape due to slight fluctuations in lithography. Examples of such fluctuations include fluctuations in exposure amount or focus, fluctuations in baking temperature, fluctuations in rinse conditions in development, and the like. When the method disclosed in the above articles is applied to such a space part, there is a possibility that the space part becomes unopen.

On the other hand, with regard to a pattern forming method of forming sidewall patterns on sidewalls of a resist pattern and patterning an underlayer by using the sidewall patterns, shift of the thicknesses of the resist pattern and the sidewall patterns causes a problem. Due to the shift of the thicknesses, a positional shift in the underlayer pattern is caused. There is a possibility that the positional shift causes, for example, electric short-circuit between lines in the same interconnect layer or lines of different interconnect layers.

### SUMMARY OF THE INVENTION

An aspect of the present invention is, for example, a pattern forming method including forming, on a substrate, a base pattern having a space part, adjusting a width of the space part to make a bottom width of the space part closer to an upper width of the space part, and forming a modified base pattern having a space part whose bottom width is smaller than the bottom width of the space part of the base pattern, by a process of forming a deposition film on the substrate and the base pattern, and a process of removing the deposition film from a bottom of the space part of the base pattern.

Another aspect of the present invention is, for example, a pattern forming method including forming, on a substrate, a base pattern having a space part, forming a modified base pattern having a space part whose bottom width is smaller than a bottom width of the space part of the base pattern, by a process of forming a deposition film on the substrate and the base pattern, and a process of removing the deposition film from a bottom of the space part of the base pattern, forming sidewall patterns each having a predetermined thickness on sidewalls of the modified base pattern, by a process of forming a deposition film on the substrate and the modified base pattern while measuring a thickness of the deposition film deposited on the sidewalls of the modified base pattern, and a process of removing the deposition film from a bottom of the space part of the modified base pattern while measuring a thickness of the deposition film deposited on the bottom of the space part of the modified base pattern, and by controlling the thickness of the deposition film formed on the sidewalls of the modified base pattern by the processes of forming and removing the deposition film while measuring the thicknesses, and removing the modified base pattern between the sidewall patterns.

Another aspect of the present invention is, for example, a pattern forming method including forming, on a substrate, a base pattern having a space part, forming sidewall patterns each having a predetermined thickness on sidewalls of the base pattern, by a process of forming a deposition film on the substrate and the base pattern while measuring a thickness of the deposition film deposited on the sidewalls of the base pattern, and a process of removing the deposition film from a bottom of the space part of the base pattern while measuring a thickness of the deposition film deposited on the bottom of the space part of the base pattern, and by controlling the thickness of the deposition film formed on the sidewalls of the base pattern by the processes of forming and removing the deposition film while measuring the thicknesses, and removing the base pattern between the sidewall patterns.

### BRIEF DESCRIPTION OF THE DRAWINGS

FIG. 1 is a flowchart with regard to a pattern forming method of a first embodiment;

FIGS. 2A to 3C are side sectional views for explaining the pattern forming method of the first embodiment;

FIG. 4 shows side sectional views for explaining a resist pattern;

FIG. 5 shows side sectional views for explaining a width of a space part of the resist pattern;

FIGS. 6A to 6C are side sectional views for explaining various layers on a substrate;

FIG. 7 is a flowchart with regard to a pattern forming method of a second embodiment;

FIGS. 8A to 9C are side sectional views for explaining the pattern forming method of the second embodiment;

FIG. 10 shows side sectional views illustrating poor precision in thickness; and

FIG. 11 shows side sectional views illustrating poor precision in thickness.

### DESCRIPTION OF THE EMBODIMENTS

Embodiments of the present invention will be described with reference to the drawings.

### First Embodiment

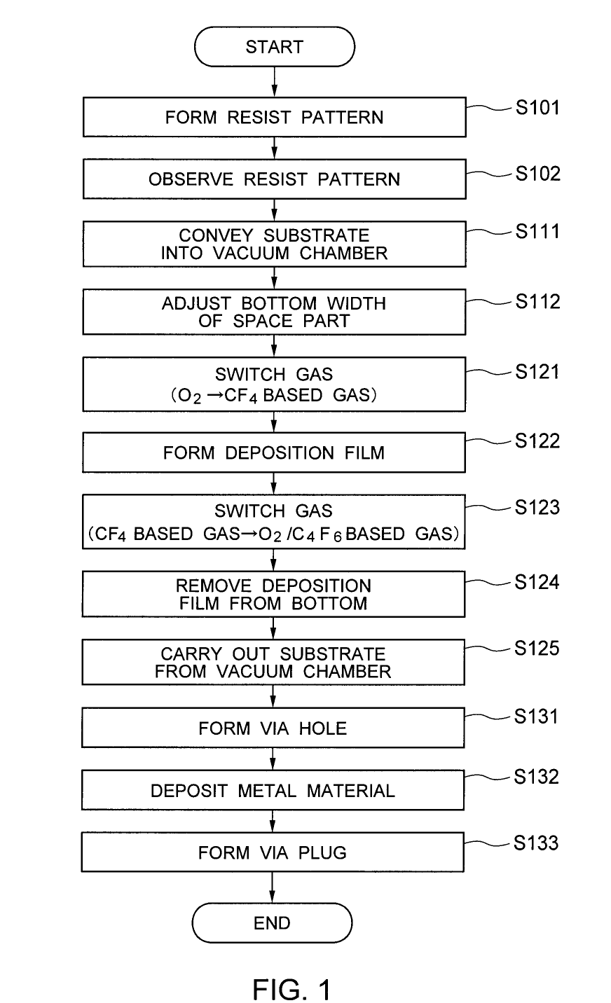

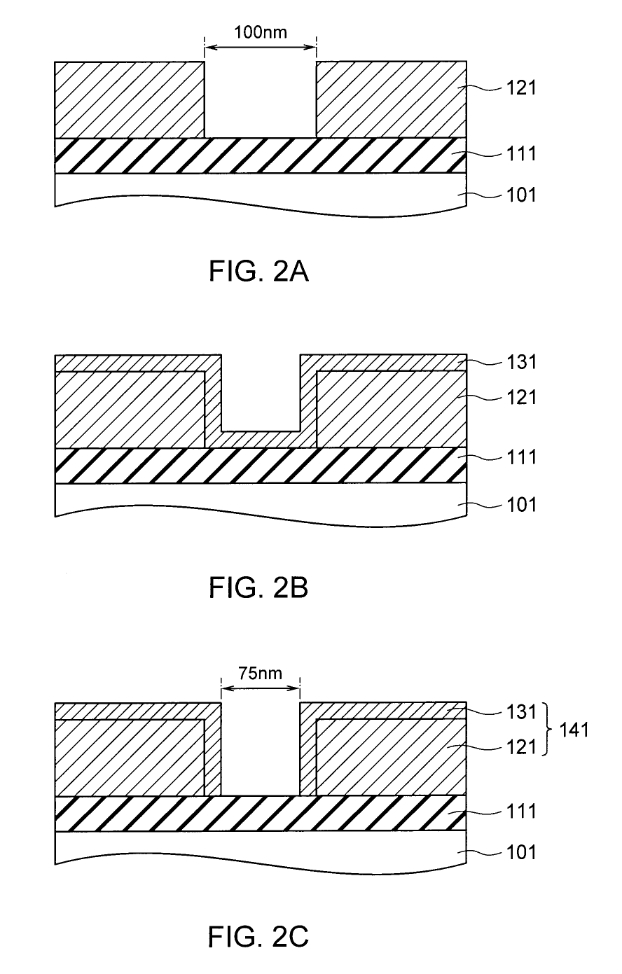

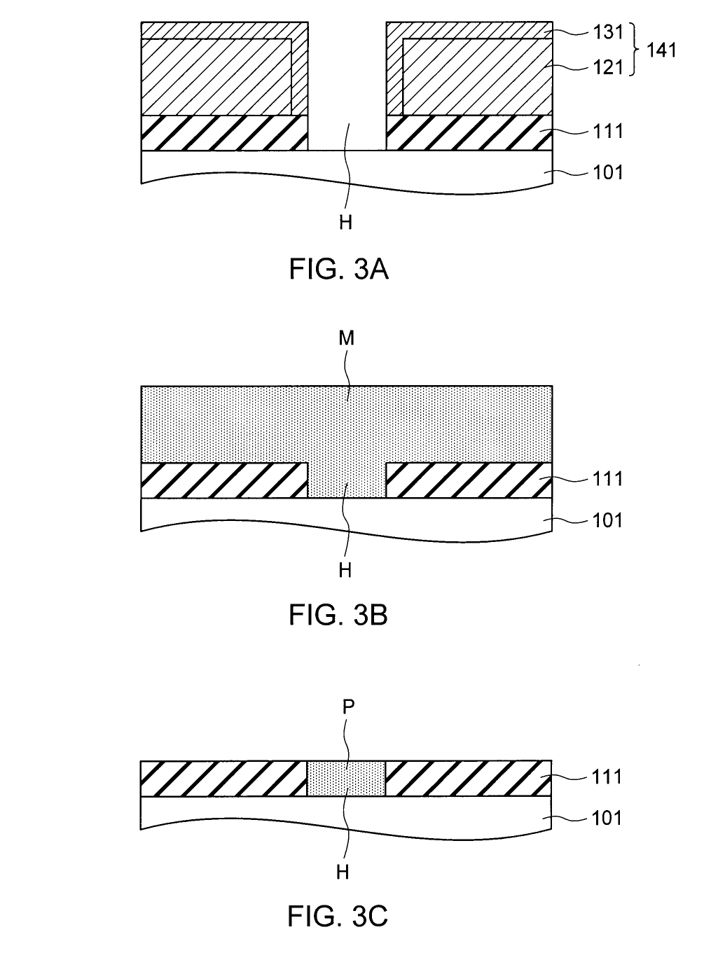

FIG. 1 is a flowchart with regard to a pattern forming method of a first embodiment. FIGS. 2A to 3C are side sectional views for explaining the pattern forming method of the first embodiment.

The pattern forming method of the first embodiment will be described below with reference to FIG. 1. In the description, FIGS. 2A to 6C will be also referred to.

First, as shown in FIG. 2A, a resist film is formed on a layer 111 to be etched, and a resist pattern 121 having a space part is formed from the resist film by exposure and development (S101). The layer 111 to be etched is provided on a substrate 101. In this case, the resist pattern 121 is a hole pattern for forming a via hole. In this embodiment, the width of the space part of the resist pattern 121 is 100 nm. The resist pattern 121 is an example of a base pattern of the present invention.

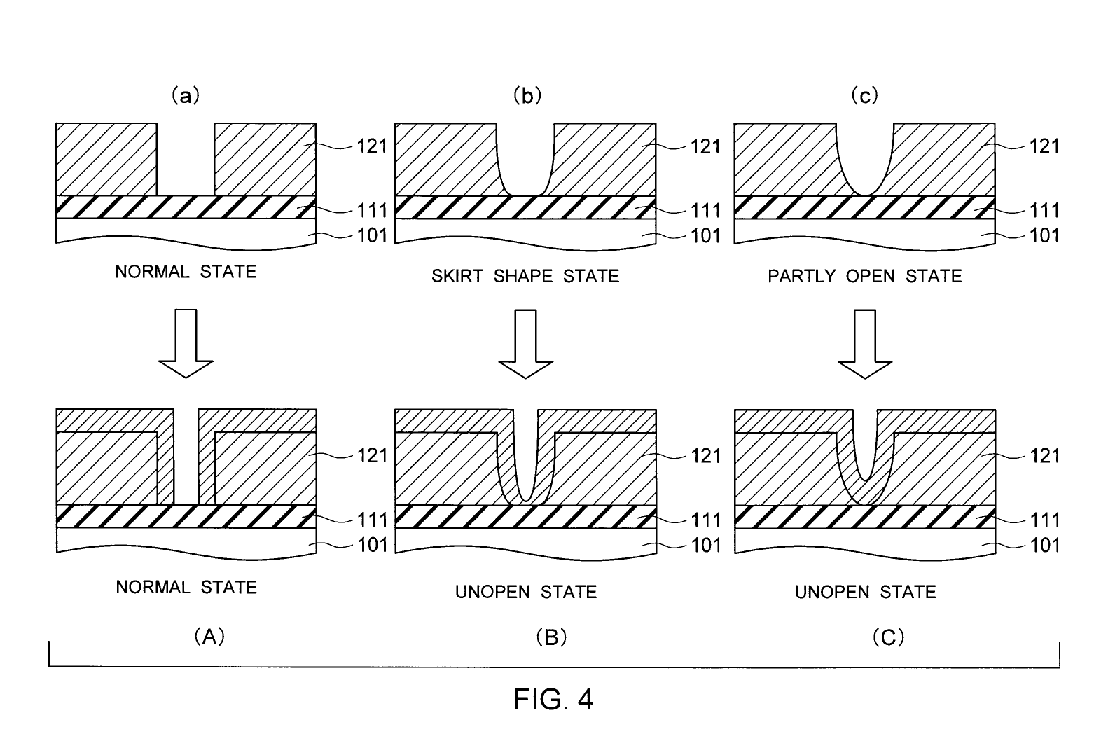

Next, the resist pattern 121 is observed from above of the substrate with a top-down SEM (Scanning Electron Microscope) (S102). It is assumed that not only a normal pattern as shown in FIG. 4(a) but also a skirt shaped pattern as shown in FIG. 4(b) and a partly open pattern as shown in FIG. 4(c) are observed. FIG. 4 shows side sectional views for explaining the resist pattern 121. When a deposition film is formed directly on the pattern shown in FIG. 4(B) or 4(C), there is a possibility that an unopen pattern as shown in FIG. 4(B) or 4(C) is formed.

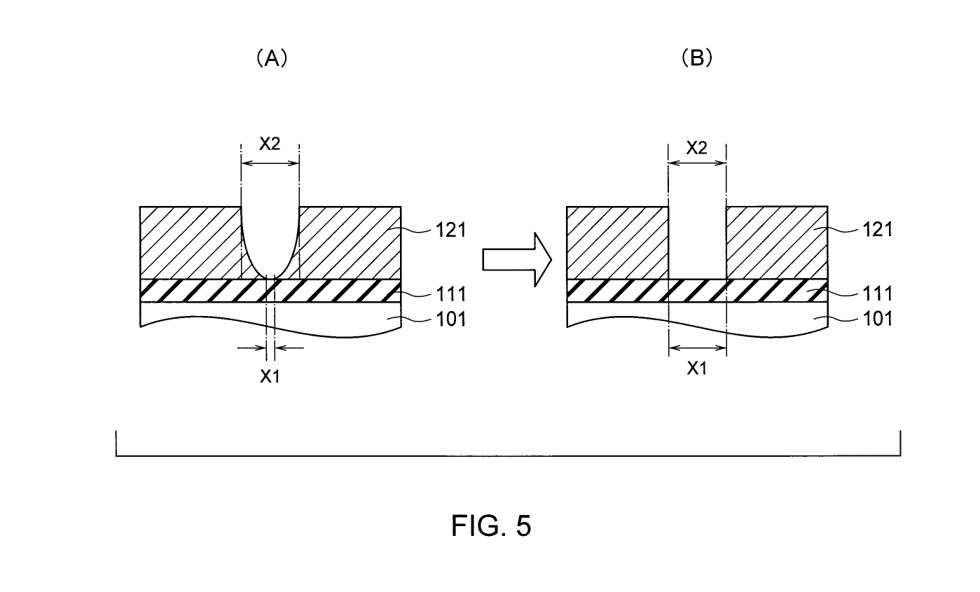

In such a case, in this embodiment, the substrate 101 is conveyed into a vacuum chamber (S111), and anisotropic etching using an oxygen gas is performed (S112). FIG. 5 shows side sectional views for explaining the width of the space part of the resist pattern 121. In FIG. 5(A), the bottom width of the space part of the resist pattern 121 is indicated by “X1”, and the upper width of the space part of the resist pattern 121 is indicated by “X2”. In this embodiment, the resist pattern 121 is etched by the anisotropic etching to adjust the bottom width “X1” to make the bottom width “X1” closer to the upper width “X2”. The main cause of a residual resist on the bottom of the space part is insufficient rinsing in the development. Therefore, in general, the number of voids in the resist remaining on the bottom is larger than that in the resist in other parts. Therefore, in the anisotropic etching, the bottom width “X1” can be increased to almost the upper width “X2” while almost maintaining the shape of the resist pattern 121, by optimizing anisotropy of gas composition, gas ratio, accelerating voltage, electric field, magnetic field and the like, and control factors of accelerating speed. According to the anisotropic etching, the resist pattern 121 as shown in FIG. 5(B) is obtained.

Next, the gas in the vacuum chamber is switched to a fluorocarbon gas (S121). The fluorocarbon gas is, for example, a CF₄, C₂F₆, or C₄F₈ based gas. Next, as shown in FIG. 2B, a deposition process is performed under conditions such that the fluorocarbon is decomposed and deposited, thereby forming a deposition film 131 made of the fluorocarbon on the substrate 101 (the layer 111 to be etched) and the resist pattern 121 (S122). Next, the gas in the vacuum chamber is switched to an oxygen gas and a fluorocarbon based gas (S123). The fluorocarbon based gas is, for example, a CF₄, C₂F₆, or C₄F₈ based gas. Next, as shown in FIG. 2C, the deposition film 131 is removed from the bottom of the space part of the resist pattern 121 by anisotropic etching, so that the layer 111 to be etched is exposed at the bottom of the space part of the resist pattern 121 (S124). After that, the substrate 101 is conveyed from the vacuum chamber (S125).

As described above, according to the processes in S122 and S124, the bottom width of the space part of the resist pattern (base pattern) 121 is adjusted with the deposition film 131. As a result, a modified base pattern 141 having a space part whose bottom width is smaller than the bottom width of the space part of the resist pattern (base pattern) 121 is formed. In this embodiment, the bottom width of the space part of the modified base pattern 141 is 75 nm.

Next, as shown in FIG. 3A, the layer 111 to be etched is etched using the modified base pattern 141 as a mask, (S131). According to the etching, a via hole H is formed. Next, as shown in FIG. 3B, a metal material M is deposited on the layer 111 (S132). According to the deposition, the metal material M is buried in the via hole H. Next, as shown in FIG. 3C, the metal material M is planarized by CMP (Chemical Mechanical Polishing) (S133). According to the planarization, a via plug P made of the metal material M is formed. In such a manner, in this embodiment, a semiconductor device is manufactured from the substrate 101.

As described above, in this embodiment, prior to the modification of the resist pattern 121, the bottom width “X1” is adjusted to make the bottom width “X1” closer to the upper width “X2”. Consequently, the number of unopened openings in the pattern can be decreased. In this embodiment, according to experiments conducted by the inventors of the present invention, the number of unopened openings in the pattern could be decreased to 1/100 or less of that in the case where this embodiment is not applied. In adjusting the bottom width “X1”, not only the bottom width “X1” but also the upper width “X2” may be finely adjusted.

In this embodiment, the modified base pattern 141 is used for forming a via hole (via plug). The modified base pattern 141 can be also used for forming a contact hole (contact plug), a line trench (line), an STI (STI layer) and the like. According to this embodiment, the space part close to the limited resolution can be further miniaturized, and this embodiment is suitable for such a process. This embodiment can improve the yield of such a process.

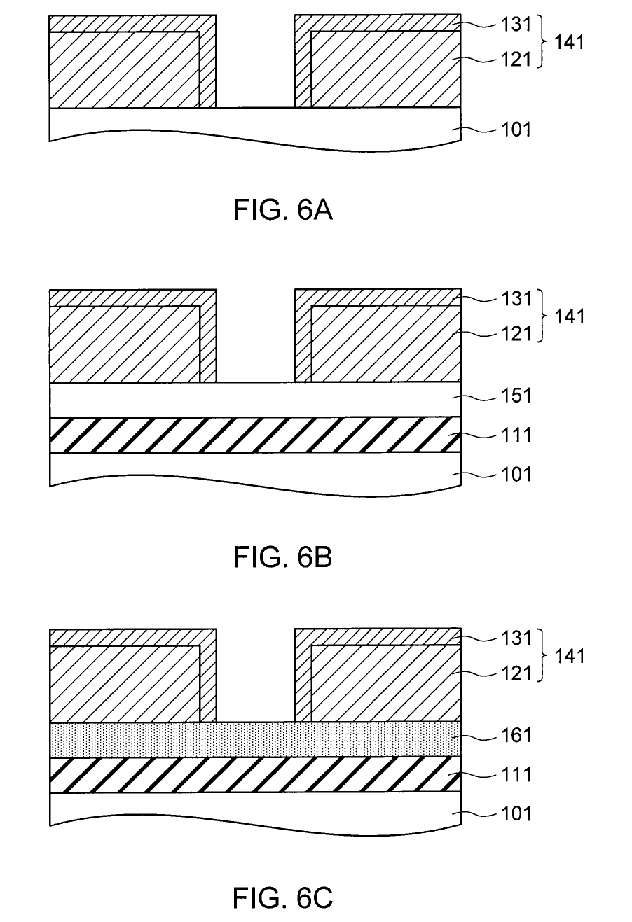

In this embodiment, the modified base pattern 141 is formed directly on the layer 111 to be etched, and the modified base pattern 141 is used for etching the layer 111 to be etched. Alternatively, in this embodiment, as shown in FIG. 6A, the modified base pattern 141 may be formed directly on the substrate 101, and the modified base pattern 141 may be used for etching the substrate 101. Also, in this embodiment, as shown in FIG. 6B, an anti-reflection coating 151 may be provided between the layer 111 to be etched (or the substrate 101) and the modified base pattern 141. Also, in this embodiment, as shown in FIG. 6C, a hard mask layer 161 may be provided between the layer 111 to be etched (or the substrate 101) and the modified base pattern 141. FIGS. 6A to 6C are side sectional views for explaining various layers on the substrate 101.

In this embodiment, the base pattern is the resist pattern 121. Alternatively, in this embodiment, the base pattern may be a hard mask pattern fabricated using the resist pattern 121. In this case, the deposition film 131 is formed on the hard mask pattern. Examples of a film forming the hard mask pattern include an oxide film, a nitride film, an organic film having high carbon content, and the like.

In the anisotropic etching of S112, anisotropy of gas composition, gas ratio, accelerating voltage, electric field, magnetic field and the like, and control factors of accelerating speed are optimized. In a case where the base pattern is a resist pattern, a degree of activity of alkaline fluid may be optimized by concentration control, addition of functional water or the like. In a case where the base pattern is an oxide film pattern, the concentration control may be performed by using fluorine.

It is desired that the anisotropic etching in S124 is controlled so that the etching rate of the deposition film 131 at the bottom of the space part of the resist pattern 121 becomes higher than the etching rate of the deposition film 131 on the sidewall of the resist pattern 121. The processes in S121 and S122 and the processes in S123 and S124 may be performed alternately and repeatedly plural times.

A pattern forming method of a second embodiment will be described below. The second embodiment is a modification of the first embodiment. Therefore, the following description on the second embodiment will be focused on the points different from the first embodiment.

### Second Embodiment

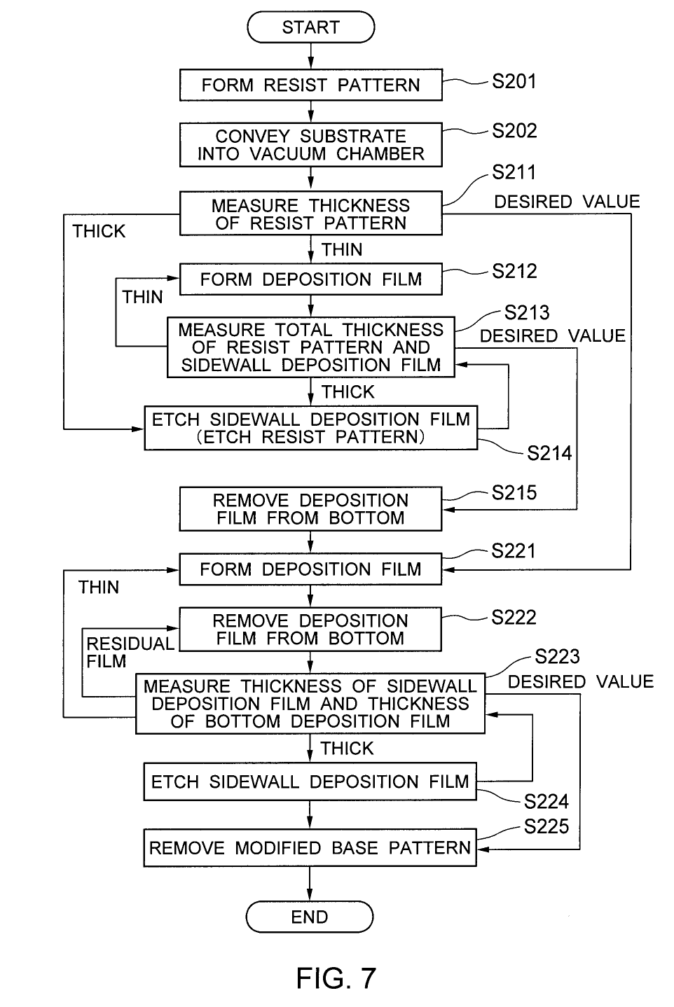

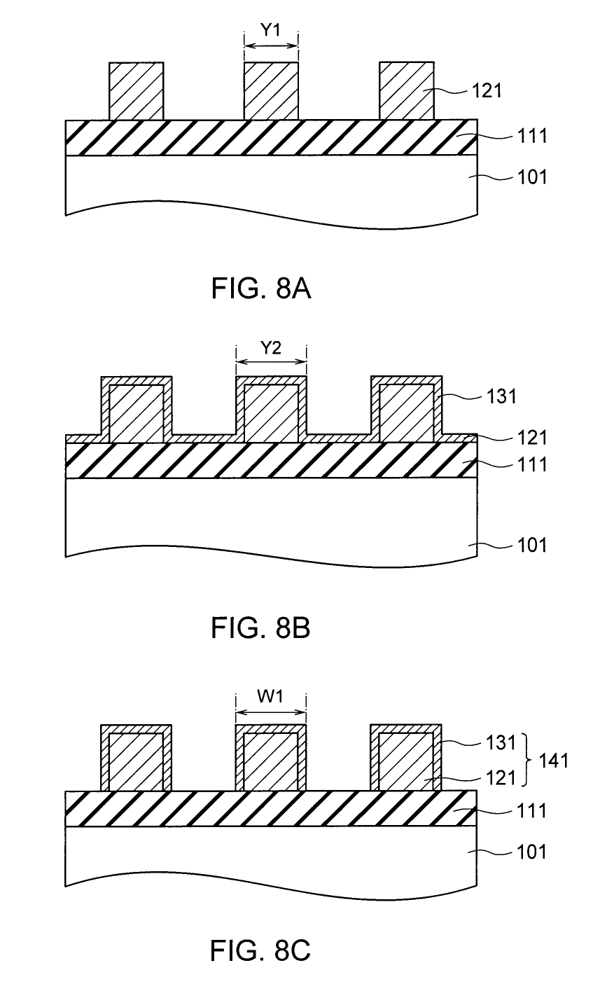

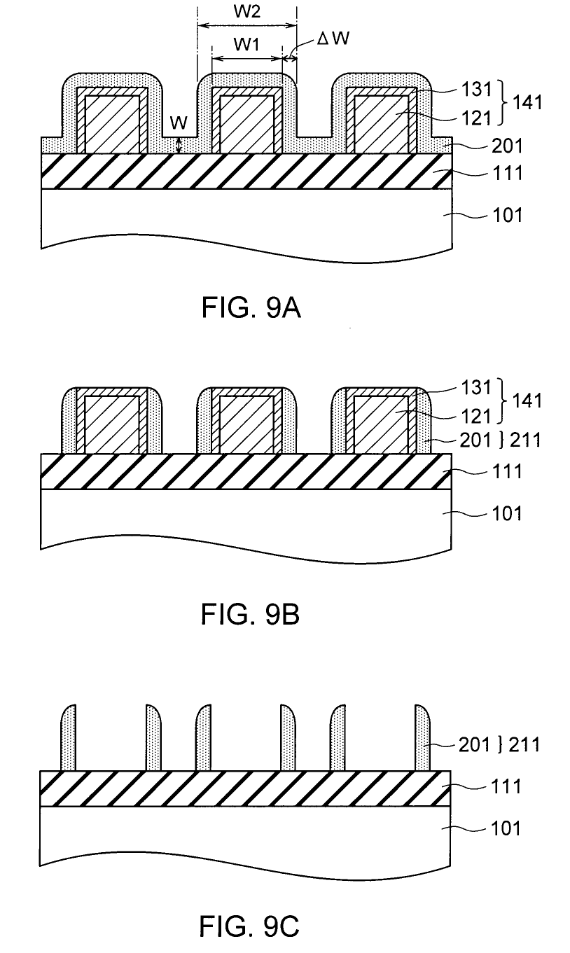

FIG. 7 is a flowchart with regard to a pattern forming method of a second embodiment. FIGS. 8A to 9C are side sectional views for explaining the pattern forming method of the second embodiment.

The pattern forming method of the second embodiment will be described below with reference to FIG. 7. In the description, FIGS. 8A to 11 will be also referred to.

First, as shown in FIG. 8A, a resist film is formed on the layer 111 to be etched, and a resist pattern 121 having a space part is formed from the resist film by exposure and development, (S201). The layer 111 to be etched is provided on the substrate 101. In this case, the resist pattern 121 is an L/S (Line and Space) pattern having a pitch P [nm]. The resist pattern 121 is an example of a base pattern of the present invention. Next, the substrate 101 is conveyed into a vacuum chamber in which a pressure can be decreased (S202). Instead of performing the process of S202, the processes of S102, S111, and S112 may be performed.

Next, the thickness (line width) of the resist pattern 121 is measured using scatterometry capable of measuring a film thickness through a window of the chamber (S211). In this embodiment, it is assumed that a design value of the line width and the space width is 0.5P [nm], but measured values of the line width and the space width are 0.48P [nm] and 0.52P [nm] respectively. In FIG. 8A, the thickness (line width) of the resist pattern 121 is indicated by “Y1”. When sidewall patterns are formed by using such a resist pattern 121, pitches of the sidewall patterns are deviated from design values.

In such a case, in this embodiment, a fluorocarbon based gas is introduced into the vacuum chamber to generate plasma. The fluorocarbon based gas is, for example, a CF₄ based gas, a CHF₃ based gas, a CH₂F₂ based gas, a C₂H₃F₃ based gas, or a C₂H₂F₄ based gas. Next, as shown in FIG. 8B, the pressure and electromagnetic field are controlled so that chemical reaction occurs easily, and a deposition film 131 made of the fluorocarbon is formed on the substrate 101 (layer 111 to be etched) and the resist pattern 121 (S212). In FIG. 8B, the total thickness of the resist pattern 121 and the deposition film 131 deposited on the sidewalls of the resist pattern 121 is indicated by “Y2”. The process in S212 is performed while measuring the total thickness “Y2” (S213). The process in S212 and the process in S213 are alternately repeated until the total thickness “Y2” becomes a desired value.

In the measurement, the intensity and the degree of polarization of reflection light are obtained by scatterometry, and the thickness of the deposition film 131 is calculated by fitting, based on the obtained values, optical constants of the layer 111, the resist pattern 121, and the deposition film 131, and the shape of the resist pattern 121 preliminarily measured. Adjustments of dimensions of the base pattern are performed based on the dimensions of the base pattern and the thickness of the deposition film calculated by the measurement. As a result, precisions of analysis and fabrication can be improved.

In a case where the total thickness “Y2” exceeds a desired value by the processes in S212 and S213, the deposition film 131 on the sidewalls of the resist pattern 121 has to be etched (S214). In performing the process of S214, an oxygen based gas is added to generate plasma in the vacuum chamber. The oxygen based gas is, for example, CO or O₂. Instead of adding the oxygen based gas, a switch to the oxygen based gas may be performed. In S214, an etching is performed under conditions in which ions can be easily drawn to the sidewalls of the resist pattern 121. By the etching, the total thickness “Y2” is brought close to the desired value, while maintaining verticality of the sidewalls.

Next, the gas in the vacuum chamber is switched to an oxygen based gas to generate plasma. The oxygen based gas is, for example, CO or O₂. Next, as shown in FIG. 8C, the pressure and electromagnetic field are controlled so that ion energy increases in the vertical direction of the substrate 101, and the deposition film 131 is removed from the bottom of the space part of the resist pattern 121 by anisotropic etching (S215). The process of S215 may be performed as needed.

As described above, according to the processes in S211 to S215, the line width and the space width of the resist pattern (base pattern) 121 are modified with the deposition film 131. As a result, a modified base pattern 141 having a space part whose bottom width is smaller than the bottom width of the space part of the resist pattern (base pattern) 121 is formed. In this embodiment, the bottom width of the space part of the modified base pattern 141 is 0.5P [nm], i.e., the line width and the space width of the modified base pattern 141 is 0.5P [nm]. In FIG. 8C, the total thickness of the resist pattern 121 and the deposition film 131 on the sidewalls of the resist pattern 121, i.e., the thickness (line width) of the modified base pattern 141 is indicated by “W1”.

In this embodiment, according to the processes in S211 to S215, dimensions of a pattern to be used for forming sidewall patterns can be accurately controlled. In this embodiment, the pattern is the modified base pattern 141. In this embodiment, the processes in S211 to S215 may be omitted. In this case, the pattern to be used for forming the sidewall patterns is the base pattern (resist pattern) 121. The pattern to be used for forming the sidewall patterns may be a hard mask pattern fabricated by using the modified base pattern 141 or the base pattern 121. In this case, the hard mask pattern may be slimmed between the process of S215 and the process of S221. The hard mask pattern is also an example of the modified base pattern or the base pattern of the present invention.

Next, in this embodiment, a sidewall pattern forming process is started in a state where the substrate 101 is set in the vacuum chamber. In the following, the pattern forming process performed by using the modified base pattern 141 is described, but the following process may be performed by using the resist pattern 121. In such a case, the modified base pattern 141 in the following description is replaced with the resist pattern 121.

Next, a silane based gas is introduced into the vacuum chamber to generate plasma. Next, as shown in FIG. 9A, the pressure and electromagnetic field are controlled so that chemical reaction occurs easily, and a deposition film 201 made of SiO₂ is formed on the substrate 101 (the layer 111 to be etched) and the modified base pattern 141 (S221). In FIG. 9A, the total thickness of the modified base pattern 141 and the deposition film 201 deposited on the sidewalls of the modified base pattern 141 (hereinafter, referred to as “sidewall deposition film 201”) is indicated by “W2”. In FIG. 9A, the thickness of the sidewall deposition film 201 is indicated by “ΔW”. Values of “W1”, “W2”, and “ΔW” satisfy the relation of ΔW=(W2−W1)/2. The process in S221 is performed while measuring the thickness “ΔW” of the sidewall deposition film 201 (S223).

Next, the gas in the vacuum chamber is switched to a fluorine based gas to generate plasma. Next, as shown in FIG. 9B, the deposition film 201 is removed from the bottom of the space part of the modified base pattern 141 by anisotropic etching, so that the layer 111 to be etched is exposed at the bottom of the space part of the modified base pattern 141 (S222). In FIG. 9A, the thickness of the deposition film 201 deposited on the bottom of the space part of the modified base pattern 141 (hereinafter, referred to as “bottom deposition film 201”) is indicated by “W”. The process of S223 is performed while measuring the thickness “W” of the bottom deposition film 201 (S223).

In the measurement of the thickness “ΔW” of the sidewall deposition film 201, “W2” is measured by scatterometry in a manner similar to the measurement in S211 to S215, and “ΔW” is calculated using “W1” measured in S211 to S225 and “W2” measured in S223. As a result, precisions of analysis and fabrication can be improved. Further, in the measurement of the thickness “W” of the bottom deposition film 201, “W” is measured by scatterometry in a manner similar to the measurement in S211 to S215. In S222 of this embodiment, since the bottom deposition film 201 is removed based on “W” instead of “ΔW”, over-etching or under-etching of the bottom deposition film 201 can be prevented effectively.

In S221 to S223, when the thickness “ΔW” of the sidewall deposition film 201 is thinner than a desired value, the processes in S221 and S222 are performed again, and the measurement of S223 is performed again. On the other hand, when the thickness “ΔW” of the sidewall deposition film 201 is thicker than the desired value, the gas in the vacuum chamber is switched to a fluorine based gas to generate plasma. Then, to etch the sidewall deposition film 201 on the modified base pattern 141, the pressure and electromagnetic field are controlled (S224). After that, the measurement of S223 is performed again. Further, when the thickness “ΔW” of the sidewall deposition film 201 is the desired value, and the bottom deposition film 201 remains, the process of S222 is performed again, and the measurement of S223 is performed again.

As described above, according to the processes in S221 to S224, the thickness of the deposition film 201 formed on the sidewalls of the modified base pattern 141 is controlled. As a result, sidewall patterns 211 each having a predetermined thickness are formed on the sidewalls of the modified base pattern 141.

Next, a carbon film made of the same kind of material as that of the deposition film 131 is formed on the modified base pattern 141 and the sidewall patterns 211. Next, the deposition film 131 included in the modified base pattern 141 is removed by CMP (Chemical Mechanical Polishing). Next, the resist pattern 121 included in the modified base pattern 141 is removed by etching using an oxygen gas. As a result, as shown in FIG. 9C, the modified base pattern 141 between the sidewall patterns 211 is removed (S225).

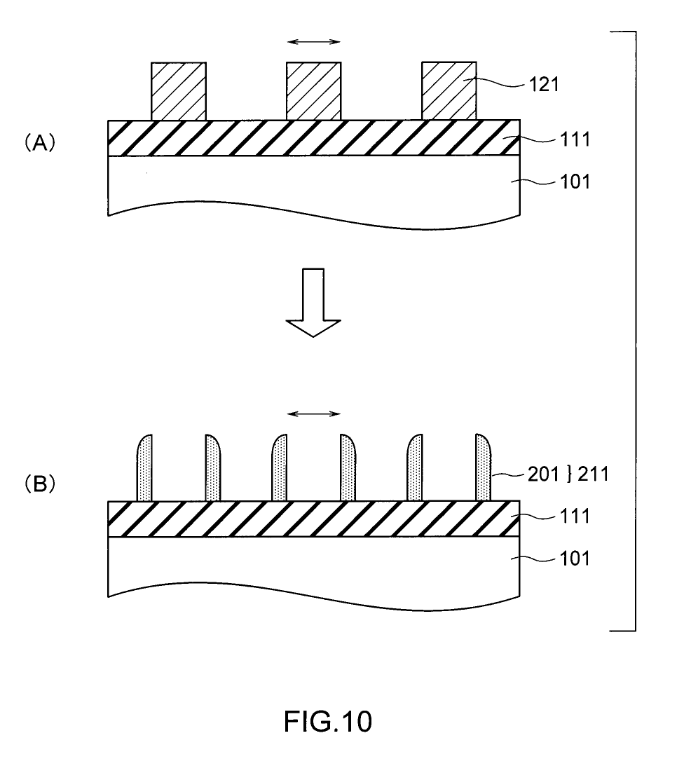

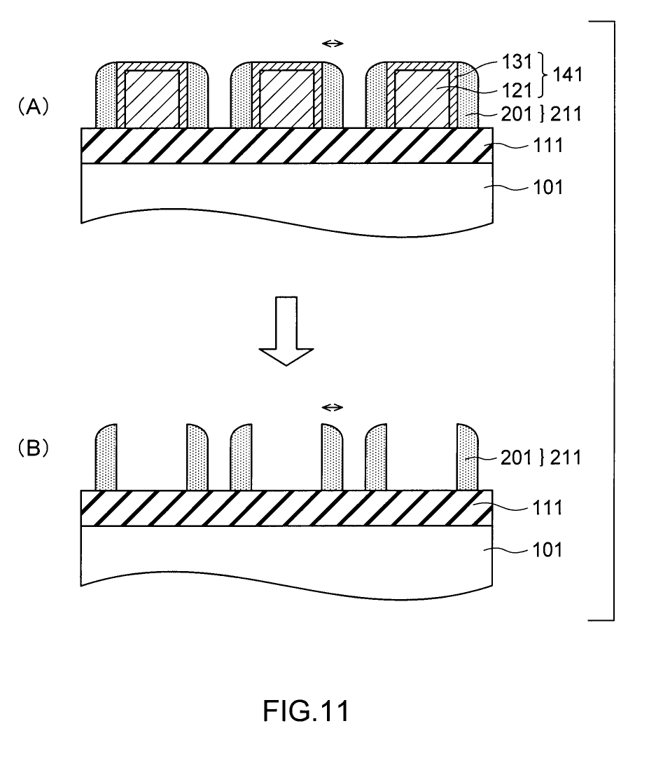

As described above, in S211 to S215, the base pattern 121 is modified with the deposition film 131. Further, in S221 to S225, the thickness of each of the sidewall patterns 211 is controlled to the predetermined thickness. Consequently, error of the thickness of the base pattern 121 (see FIG. 10) and error of the thickness of each of the sidewall patterns 211 (see FIG. 11) are adjusted, and positional shift of an underlayer pattern is suppressed. FIGS. 10 and 11 show side sectional views for explaining inaccurate thicknesses. The measurement of the thickness in S211 to S215 and the measurement of the thickness in S221 to S225 are effective to control these thicknesses to the desired thicknesses. The underlayer can be etched, for example, as in S131 to S133.

In this embodiment, various thicknesses are measured by scatterometry. In the measurement, for example, a film to be measured is irradiated with light whose wavelength or polarization plane is changed, reflection light of the irradiated light is measured, and the thickness of the film is calculated using the result of measuring the reflection light, and optical constants of the substrate 101, the layer 111, the base pattern 121, the deposition film 131, the deposition film 201 and the like. In the calculation, precisions of the calculated value can be increased by using shape information such as line widths and sidewall angles of the base pattern 121 and the modified base pattern 141 which are preliminarily measured for analysis. In the measurement of the thickness of the bottom deposition film 201, it is also possible to measure the spectrum of light in removing the bottom deposition film 201, and finish the etching of the bottom deposition film 201 by using the time point when a large change occurs in the intensity of the light as a reference. With regard to the anisotropic etching on the deposition film 201, the balance of the anisotropic etching may be varied according to the thickness of the sidewall deposition film 201 and the thickness of the bottom deposition film 201. In a case where the sidewall deposition film 201 has to be etched together with the bottom deposition film 201, it is preferable to adjust a factor of controlling the etching direction such as the electric field and the magnetic field so that the etching rate is increased not only in the perspective direction but also the sidewall direction.

As described above, the embodiments of the present invention can propose a pattern forming method capable of improving a precision of a pattern formed on a substrate.

Although specific examples of aspects of the present invention have been described by the first and second embodiments, the present invention is not limited to these embodiments.

What is claimed is:

1. A pattern forming method comprising:
forming, on a substrate, a base pattern having a space part;
adjusting a width of the space part to make a bottom width of the space part closer to an upper width of the space part; and
forming a modified base pattern having a space part whose bottom width is smaller than the bottom width of the space part of the base pattern, by a process of forming a deposition film on the substrate and the base pattern, and a process of removing the deposition film from a bottom of the space part of the base pattern.

2. The method according to claim 1, wherein
the adjustment of the width of the space part and the formation of the modified base pattern are performed in the same chamber.

3. The method according to claim 1, wherein
the adjustment of the width of the space part is performed by anisotropic etching.

4. The method according to claim 1, wherein the base pattern is a resist pattern or a hard mask pattern.

5. The method according to claim 1, wherein the modified base pattern is used for etching the substrate.

6. The method according to claim 1, wherein the modified base pattern is used for etching a layer to be etched, which is provided between the substrate and the modified base pattern.

7. The method according to claim 1, wherein
the process of removing the deposition film is performed by anisotropic etching in which an etching rate of the deposition film at the bottom of the space part of the base pattern is controlled to be higher than an etching rate of the deposition film on a sidewall of the base pattern.

8. The method according to claim 1, wherein
the process of forming the deposition film and the process of removing the deposition film are performed alternately and repeatedly.

9. A pattern forming method comprising:
forming, on a substrate, a base pattern having a space part;
forming a modified base pattern having a space part whose bottom width is smaller than a bottom width of the space part of the base pattern, by a process of forming a deposition film on the substrate and the base pattern, and a process of removing the deposition film from a bottom of the space part of the base pattern;
forming sidewall patterns each having a predetermined thickness on sidewalls of the modified base pattern, by a process of forming a deposition film on the substrate and the modified base pattern while measuring a thickness of the deposition film deposited on the sidewalls of the modified base pattern, and a process of removing the deposition film from a bottom of the space part of the modified base pattern while measuring a thickness of the deposition film deposited on the bottom of the space part of the modified base pattern, and by controlling the thickness of the deposition film formed on the sidewalls of the modified base pattern by the processes of forming and removing the deposition film while measuring the thicknesses; and
removing the modified base pattern between the sidewall patterns.

10. The method according to claim 9, wherein the measurement of the thickness of the deposition film on the sidewalls of the modified base pattern comprises:
measuring a total thickness of the modified base pattern and the deposition film on the sidewalls of the modified base pattern; and
calculating the thickness of the deposition film on the sidewalls of the modified base pattern, using the thickness of the modified base pattern and the total thickness.

11. The method according to claim 9, wherein
in forming the sidewall patterns, the process of forming the deposition film and the process of removing the deposition film are performed in the same chamber.

12. The method according to claim 11, wherein
the measurement of the thickness of the deposition film on the sidewalls of the modified base pattern, and the measurement of the thickness of the deposition film at the bottom of the space part of the modified base pattern are performed by using scatterometry capable of measuring a film thickness through a window of the chamber.

13. The method according to claim 9, wherein
in forming the sidewall patterns,
in a case where the thickness of the deposition film on the sidewalls of the modified base pattern is thinner than the predetermined thickness after performing the process of forming the deposition film and the process of removing the deposition film, the process of forming the deposition film and the process of removing the deposition film are performed again, and
in a case where the thickness of the deposition film on the sidewalls of the modified base pattern is thicker than the predetermined thickness after performing the process of forming the deposition film and the process of removing the deposition film, a process of etching the deposition film on the sidewalls of the modified base pattern is performed.

14. The method according to claim 9, wherein the sidewall patterns are used for etching the substrate, or etching a layer to be etched, which is provided between the substrate and the sidewall patterns.

15. A pattern forming method comprising:
forming, on a substrate, a base pattern having a space part;
forming sidewall patterns each having a predetermined thickness on sidewalls of the base pattern, by a process of forming a deposition film on the substrate and the base pattern while measuring a thickness of the deposition film deposited on the sidewalls of the base pattern, and a process of removing the deposition film from a bottom of the space part of the base pattern while measuring a thickness of the deposition film deposited on the bottom of the space part of the base pattern, and by controlling the thickness of the deposition film formed on the sidewalls of the base pattern by the processes of forming and removing the deposition film while measuring the thicknesses; and
removing the base pattern between the sidewall patterns.

16. The method according to claim 15, wherein the measurement of the thickness of the deposition film on the sidewalls of the base pattern comprises:
measuring a total thickness of the base pattern and the deposition film on the sidewalls of the base pattern; and
calculating the thickness of the deposition film on the sidewalls of the base pattern, using the thickness of the base pattern and the total thickness.

17. The method according to claim 15, wherein
in forming the sidewall patterns, the process of forming the deposition film and the process of removing the deposition film are performed in the same chamber.

18. The method according to claim 17, wherein
the measurement of the thickness of the deposition film on the sidewalls of the base pattern, and the measurement of the thickness of the deposition film at the bottom of the space part of the base pattern are performed by using scatterometry capable of measuring a film thickness through a window of the chamber.

19. The method according to claim 15, wherein
in forming the sidewall patterns,
in a case where the thickness of the deposition film on the sidewalls of the base pattern is thinner than the predetermined thickness after performing the process of forming the deposition film and the process of removing the deposition film, the process of forming the deposition film and the process of removing the deposition film are performed again, and
in a case where the thickness of the deposition film on the sidewalls of the base pattern is thicker than the predetermined thickness after performing the process of forming the deposition film and the process of removing the deposition film, a process of etching the deposition film on the sidewalls of the base pattern is performed.

20. The method according to claim 15, wherein the sidewall patterns are used for etching the substrate, or etching a layer to be etched, which is provided between the substrate and the sidewall patterns.
